(19) United States
(12) Patent Application Publication
(10) Pub. No.: US 2026/0052144 A1
(43) Pub. Date: Feb. 19, 2026

(54) SECURE COMMUNICATION SYSTEM AND METHOD

(71) Applicant: SITA Information Networking Computing UK Limited, Hayes (GB)

(72) Inventors: Sanjay RAINA, Hayes (GB); Andrew POWELL, Cointrin (CH); Richard FISHER, Hayes (GB); Sultan KHASHAB, Hayes (GB)

(21) Appl. No.: 19/301,225

(22) Filed: Aug. 15, 2025

Related U.S. Application Data
(63) Continuation of application No. PCT/GB2023/050556, filed on Mar. 9, 2023.

(51) Int. Cl. H04L 9/40

(52) U.S. Cl. CPC H04L 63/0838; H04L 63/0884

(57) ABSTRACT

A method of secure communication between a device and a computer program running on a server is disclosed. The method comprising the steps of: sending, from the device to the server, generic user identification information based on a current user account logged into on the device; identifying, by the server, the generic user identification information as corresponding to an allowed entity pre-registered with the server; sending, from the server to a remote management module, an identification token associated with the allowed entity, said remote management module having stored thereon a register of registered devices; running, by the remote management module, a remote action on the device using the stored register entry for that device, wherein the remote action passes the identification token to the device; sending, from the device to the server, the identification token; and allowing the device to access the computer program based at least in part on a match between the identification token sent by the server and the identification token received by the server from the device.

### TECHNICAL FIELD

This application relates to a secure communication system and method, and in particular to a system and method for secure communication between a device and a computer program running on a server. In some embodiments, the computer program may be a virtual agent function running in an omnichannel system.

### BACKGROUND ART

Omnichannel customer engagement refers to the ability of a company to provide its customers access to its products and services via multiple communication channels, offering a seamless, integrated customer experience. It allows customers to get in touch whenever and wherever they are, with conversations and their context being maintained when the customer switches from one channel to another. A customer may initiate contact with a company via phone and then continue the conversation via email, followed by an interaction with a support agent via chat, all the while maintaining continuity in the conversation.

Companies are also adding automated bots to these omnichannel systems to provide virtual agent functionality, providing more immediate response to their customers. Chatbots are a good way to enable common, frequently asked queries to be responded to. Likewise, voicebots are replacing conventional interactive voice response (IVR) systems to provide a conversational customer experience via voice.

Omnichannel solutions have been provided by companies in business to consumer scenarios, typically in a call centre setting, e.g. consumers checking their booking or flight information in the airline or travel industry, or consumers checking on their plans or device information with their telecommunications provider. In such cases, users are typically authenticated by entering an individual username and a password each time they access the omnichannel system.

These known omnichannel solutions have a number of limitations against their adoption in certain sectors, particularly when it comes to security and authentication of users. For example, the air transport industry (ATI) and other transportation and passenger processing sectors present a unique set of challenges when it comes to customer support. In the ATI in particular, customers of a company providing an omnichannel system can include airlines and airport operators, rather than direct consumers in the public. Further, the customers can themselves employ a chain of third party suppliers (so called “indirect consumers”), e.g. ground handlers, that need to interact with the omnichannel system for customer and technical support. Such situations can lead to difficulties in authenticating the person attempting to connect via a communication channel.

Specifically, companies operating in sectors which do not deal directly with an end consumer do not manage all of the specific user identities of their customers, i.e. all specific employees of a customer. The identity management of the specific users is the responsibility of their employing organisations. Further, all employees of external users, such as third party suppliers, will also not be registered with the omnichannel system. This creates an issue when enabling self-service capabilities through a virtual agent functionality. Access to data and functionality should be limited to that owned by or relevant to a particular customer. Since the user's specific identity cannot be verified, it is not possible to securely authenticate the user and therefore securely provide access to the data and actions relevant to particular customers. Without authenticating the user, controlled access to customer data and backend services to automate the resolution of issues cannot be allowed, as there is a risk one customer could access another customer's data. At best only general, public information can be provided in responses.

We have appreciated that it would be desirable to provide an omnichannel system that can allow customers and their suppliers to access the omnichannel system in a secure manner, without knowledge of the specific identity of the user.

### SUMMARY OF THE INVENTION

The invention is defined by the independent claims, to which reference should now be made. Advantageous features are set out in the dependent claims.

According to a first aspect of the invention, a method of secure communication between a device and a computer program running on a server is provided. The method comprises the steps of: sending, from the device to the server, generic user identification information based on a current user account logged into on the device; identifying, by the server, the generic user identification information as corresponding to an allowed entity pre-registered with the server; sending, from the server to a remote management module, an identification token associated with the allowed entity, said remote management module having stored thereon a register of registered devices; running, by the remote management module, a remote action on the device using the stored register entry for that device, wherein the remote action passes the identification token to the device; sending, from the device to the server, the identification token; and allowing the device to access the computer program based at least in part on a match between the identification token sent by the server and the identification token received by the server from the device.

Optionally, the method further comprises the steps of: generating, by the server, a one-time authentication token; sending, from the server to the remote management module, the one-time authentication token along with the identification token; passing the one-time authentication token to the device along with the identification token; sending, by the device to the server, the one-time authentication token along with the identification token; allowing the device to access the computer program based at least in part on a match between the one-time authentication token generated by the server and the one-time authentication token received by the server from the device.

Optionally, the one-time authentication token is a randomly generated code.

Optionally, the generic user identification information comprises one or both of: an organisation name associated with the current user account logged into on the device, and/or a location associated with the device.

Optionally, the generic user identification does not include the identity of the specific person using the device.

Optionally, the identifying the generic user identification information as corresponding to an allowed entity comprises: confirming that the organisation name and/or the location appear in a list of allowed organisations and/or locations pre-registered with the server with permission to access the computer program.

Optionally, the generic user identification information comprises both the organisation name associated with the current user account logged into on the device and the location associated with the device; and identifying the generic user identification information as corresponding to an allowed entity comprises: confirming that the organisation name and location pair appear in a list of allowed organisation and location pairs pre-registered with the server with permission to access the computer program.

Optionally, the identifying the generic user identification information as corresponding to an allowed entity is independent of the identity of the specific person using the device.

Optionally, the method further comprises the step of: preventing the device from accessing, via the computer program, data and/or functionality for which the organisation name and/or the location of the generic user identification information lacks permission.

Optionally, the data for a plurality of organisations is stored in a data storage unit, with data for each organisation stored in a different domain; and the method further comprises the step of: preventing the device from accessing, via the computer program, any storage domain other than the storage domain containing data of the organisation associated with the current user account logged into on the device.

Optionally, the server includes stored thereon an identification token for each allowed entity pre-registered with the server.

Optionally, each allowed entity is an allowed organisation name and/or location, preferably an allowed organisation name and location pair.

Optionally, the identification token is a digest code generated by performing a hash function on the allowed organisation name and/or location.

The method of any preceding claim, wherein the device is installed in one of: an airport, a train station, a port, or a transportation terminal.

Optionally, the generic user identification information comprises one or both of: an airline name or ground handling agency name associated with the user account logged into on the device, and/or an airport in which the device is installed.

Optionally, the device is any one of: a tablet; a smart phone; a mobile device; a common use terminal equipment, CUTE, device; a multi-tenancy device; a connected device; an airport workstation; a kiosk; a self-bag drop unit; a biosecurity device.

Optionally, the method further comprises the step of: sending, from the workstation to the server, along with the generic user identification information, at least one of: a hostname of the device; a device identification code for the device included in the register of registered devices; and information indicative of a node of the remote management module associated with the device.

Optionally, the method further comprises the step of: sending, from the server to the remote management module, along with the identification token, at least one of: the device identification code for the device included in the register of registered devices; and the information indicative of a node of the remote management module associated with the device.

Optionally, the method further comprises the step of: performing a check that the identification token passed to the device from the remote management module matches the current user account logged into on the device.

Optionally, the computer program is a virtual agent function.

Optionally, the method further comprises the steps of: inputting, by a user of the device, an input query to the virtual agent function; processing the input query using a natural language understanding, NLU, module to determine an intent of the input query; and performing an automated action by the virtual agent function based on the determined intent.

Optionally, the virtual agent function is an automated chatbot and the input query is a text command input via the device.

Optionally, the virtual agent function is an automated voicebot; the input query is a voice command input via the device; and the method further comprises: converting, via a speech to text module, the voice command to a text command prior to the processing by the NLU module.

Optionally, the method further comprises the step of: translating the input query from a first language to a second language prior to the processing by the NLU module.

Optionally, the NLU module is trained using a data set comprising air transport industry specific terminology.

Optionally, the method further comprises the steps of: inputting, by a user of the device, a selection of a first prompt from a plurality of prompts presented by the virtual agent function on the device; performing an automated action by the virtual agent function based on the selected prompt.

Optionally, the automated action is at least one of: instructing the remote management module to perform a remote action on the device; instructing the remote management module to reboot the device or a peripheral device connected to the device; instructing the remote management module to restart a service running on the device; instructing the remote management module to perform a remediation action on the device or a peripheral device connected to the device; instructing the remote management module to perform a health check on the device, and optionally displaying a report of the health check on the device; logging a record with a central database.

Optionally, the device is a first device, and the automated action comprises logging a fault with a second device with a central database.

Optionally, the automated action comprises retrieving data from a data storage unit and outputting the data to the user of the device.

Optionally, the retrieving data and/or outputting the data is conditional on an organisation name associated with the current user account logged into on the device and/or a location associated with the device.

Optionally, the automated action comprises initiating a communication channel with a live agent.

Optionally, the method further comprises the steps of: receiving an input from the user of the device in a first language; translating in real time, by a dynamic translation module, the input into a second language set by the live agent.

According to a second aspect of the invention, a secure communication system is provided. The system comprises: a device; a server having a computer program running thereon; and a remote management module having stored thereon a register of registered devices; wherein: the device is configured to send to the server generic user identification information based on a current user account logged into on the device; the server is configured to identify the generic user identification information as corresponding to an allowed entity and subsequently send an identification token associated with the allowed entity to the remote management module; the remote management module is configured to run a remote action on the device using the stored register entry for that device, wherein the remote action is configured to pass the identification token to the device; the device is configured to send the identification token to the server; and the server is configured to allow the device to access the computer program based at least in part on a match between the identification token sent by the server and the identification token received from the device.

The secure communication method and system according to the present invention provides a number of advantages. Firstly, the authentication process provides secure controlled access to customer's data and services in the backend systems, with access to data and functionality limited to that owned by or relevant to a particular customer. Secure access is enabled without the omnichannel operator needing to know the specific end user (i.e. employees) of each customer operating the device. Instead, access to the computer program on the server can be securely enabled based only on the generic user identification information, i.e. at the customer level (e.g. company and location/airline and airport), not based on the individual users employed by the customer.

Further, the secure communication method enables secure access without each end user (i.e. customer employee) having to enter an individual username and a password each time they access the omnichannel system. This is because the method allows authentication via the remote management module passing the identification token to the device without any intervention from the user, and without the omnichannel operator needing to manage the specific identities of the employees of each customer.

### BRIEF DESCRIPTION OF THE DRAWINGS

Embodiments of the invention will now be described in relation to the accompanying drawings, in which:

FIG. 1 shows a secure communication system according to an embodiment of the present invention;

FIG. 2 shows a logical architecture of a secure communication system in an embodiment of the present invention;

FIG. 3a shows a flow chart of a secure communication method according to an embodiment of the present invention;

FIG. 3b shows a secure communication method according to an embodiment of the present invention;

FIG. 4a shows a self-service interaction with a virtual agent function in an embodiment of the present invention;

FIG. 4b shows a self-service interaction with a virtual agent function in an embodiment of the present invention;

FIG. 4c shows a self-service interaction with a virtual agent function in an embodiment of the present invention;

FIG. 5a shows a self-service interaction with a virtual agent function in an embodiment of the present invention;

FIG. 5b shows a self-service interaction with a virtual agent function in an embodiment of the present invention;

FIG. 6 shows an NLU processing method and a self-service interaction with a virtual agent function in an embodiment of the present invention;

FIG. 7a shows a self-service interaction with a virtual agent function in an embodiment of the present invention;

FIG. 7b shows a self-service interaction with a virtual agent function in an embodiment of the present invention;

FIG. 7c shows a self-service interaction with a virtual agent function in an embodiment of the present invention;

FIG. 8a shows an agent console with dynamic translation in an embodiment of the present invention;

FIG. 8b shows an agent console with dynamic translation in an embodiment of the present invention.

### DETAILED DESCRIPTION

### Omnichannel System

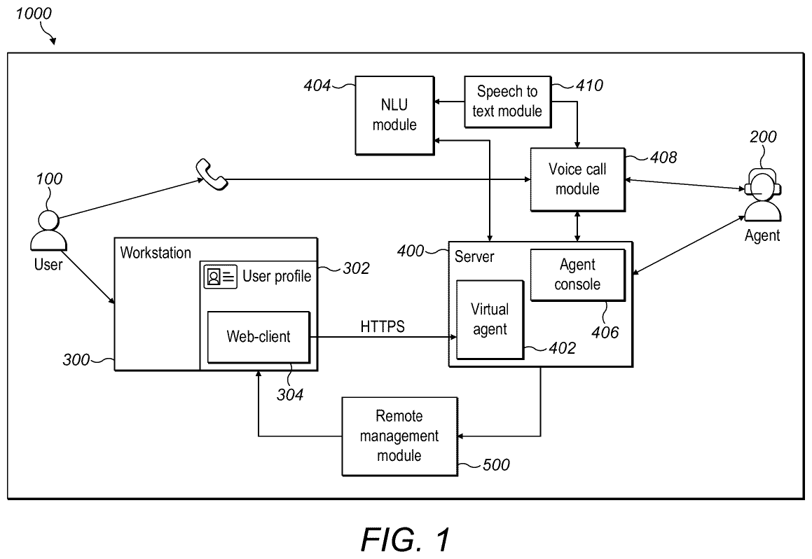

FIG. 1 shows a secure communication system 1000 according to an embodiment of the present invention. The secure communication system 1000 can be an omnichannel system enabling a user 100 to securely access customer support or technical assistance, or in some cases securely communicate with a live agent 200 of the operator of the omnichannel system. The secure communication system 1000 will therefore also be referred to as an omnichannel system herein.

The secure communication system 1000 includes a device 300 and a server 400. The device 300 may be any suitable device through which the user 100 can access the omnichannel system, for example a computer, a smartphone, a tablet, a mobile device or the like. In some embodiments, the device 300 may be a common use terminal equipment (CUTE) device or a multi-tenancy device which is shared between multiple customers. In an ATI setting, these customers could include different airlines or ground handling companies, for example. The device 300 may also be any other connected device through which the user 100 can access the omnichannel system, such as an airport workstation, a kiosk such as an automated check-in kiosk, a self-bag drop unit or an airport a biosecurity device.

In the embodiment shown in FIG. 1, the device 300 is an airport workstation. Therefore the device 300 will also be referred to as a workstation 300 herein, although it is not limited thereto. Further, although described in relation to use in an airport setting in the following description, the secure communication system 1000 may be used for various other applications. The secure communication system 1000 may in particular be used in other passenger related processing areas, such as in a train station, a port, a transportation terminal, or in hotels or the like.

The device 300 is able to communicate with the server 400, for example via HTTPS. The server 400 acts as a service management system, providing the user 100 access to data and functionality via the workstation 300. For example, the server 400 has running thereon a computer program to which the workstation 300 can be allowed access. In the present embodiment, the computer program is a virtual agent program 402, such as a chatbot or a voicebot running on the server, however other computer programs may be used.

As part of the omnichannel system, the user 100 may wish to access the virtual agent program 402 to access data, ask questions and technical queries, report issues or incidents or fault, and so on. For example, in the ATI in particular, ground staff typically use a CUTE workstation, provided and managed by the operator of the omnichannel system, for passenger and baggage check-in processes. These workstations 300 may also have peripherals such printers and scanners attached. If there is a malfunction with any of these devices, the airline agent or baggage hander may wish to seek support via the omnichannel system 1000 to resolve the issue.

Specifically, the user 100 may be logged into a user profile 302 on the workstation 300, and may access the virtual agent 402 via a web client 304 on the workstation 300. For example, the desktop of the workstation 300 may include a short-cut link to enable the ground staff to connect to service support. The shortcut runs an app that launches the web client 304 that connects to the virtual agent 402 running on the server.

In the case that the computer program is a virtual agent chatbot, the user 100 can converse with the virtual agent 402, for example by typing on a keyboard of the workstation 300. The virtual agent 402 can communicate with a natural language understanding (NLU) module 404 able to determine the user's intent from their input. The virtual agent 402 can then proceed with an appropriate automated action based on the determined intent. In that way, the virtual agent 402 can assist the user 100 of the workstation 300 with any queries they have.

In the embodiment of FIG. 1, the NLU module 404 is shown separately to server 400. For example, the NLU module 404 may be hosted in the cloud. However, the NLU module 404 may also be included in the server 400 in some embodiments, or may form part of the virtual agent computer program 402 itself in some embodiments.

In some cases, the user 100 may wish to converse with the live agent 200. Therefore in some embodiments, one functionality of the computer program includes facilitating communication between the user 100 and the live agent 200. In the specific embodiment of FIG. 1, this can involve the user 100 accessing the virtual agent 402 via the workstation 300, and the virtual agent 402 passing the communication channel onto the agent, i.e. the server 400 can transfer the chat to a live service desk agent 200. This transfer to a live agent 300 may be an automated action performed by the virtual agent 402 in response to the NLU module 404 determining that the user 100 wishes to speak to a live agent.

As shown in FIG. 1, the agent 200 may communicate with the user via an agent console 406. The agent console may be a computer program running on the server 400, or alternatively could run on a separate device, such as an agent device/workstation away from the user workstation 300. Once the user and agent are connected, both can type messages into their respective workstations in order to converse.

Alternatively, communication between the user 100 and agent 200 can be facilitated via voice. For example, the user 100 may input speech at the workstation 300, e.g. via a headset. Alternatively, the device 300 may be a mobile phone or smartphone or the like, through which the user 100 may input the speech command. A voice call module 408 may optionally be provided, to facilitate voice calls from the user 100. Again the voice call module 408 is shown separate from the server 400 in FIG. 1, and may be hosted in the cloud in some examples. However the voice call module 408 may also be included in the server 400 in some embodiments.

The voice call module 408 can transfer a voice input by the user 100 to a speech to text module 410, which converts the voice input to textual data. Again the speech to text module 410 may be separate from the server, e.g. in the cloud, or included in the server. The textual data from the speech to text module 410 can be passed to the NLU module 404 to determine the user's intent. The virtual agent 402 can then converse with the user, with the virtual agent typically being a voicebot communicating via voice if the user has initiated contact with a voice call, e.g. by using speech synthesis software or pre-recorded audio clips to speak back to the user 100. The virtual agent voicebot can again complete automated actions based on the determined intent from the speech input.

In the case that the user requests to speak with a live agent 200, the virtual agent 402 can connect the user 100 to the agent 200 via the voice call module 408, and the agent 200 can then then converse with the user 100, e.g. via a headset at the agent device, or via a mobile phone of the agent 200.

In this way, the user 100 may input either a chat or voice command via the device 300 to the server 400, and the virtual agent 402 running on the server 400 can perform an automated action in response to the input, which may include putting the user 100 into either chat or voice communication with the live agent 200.

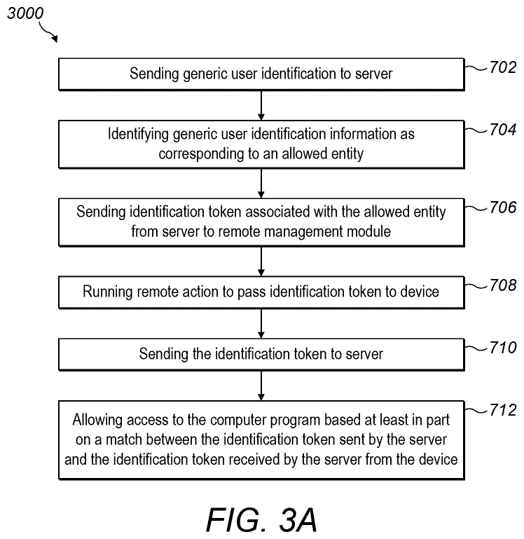

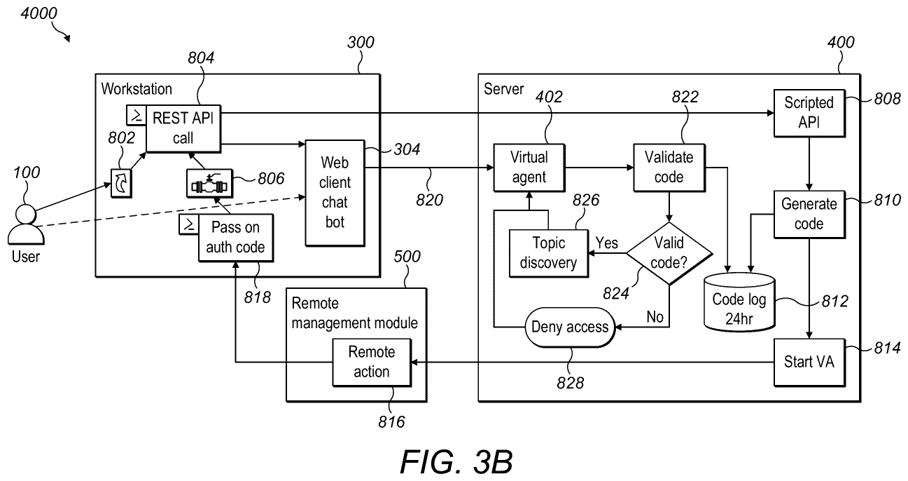

The secure communication system 1000 also includes a remote management module 500 communicatively coupled to the server 400. The remote management module 500 includes a stored register of all devices managed by the omnichannel system operator. In other words, all devices within the system operator's network that can be used to access the omnichannel system are registered with the remote management module 500. The remote management module 500 is used for the authentication of users, as will be described in more detail in relation to FIGS. 3a and 3b below.

The above described secure communication system 1000 and omnichannel solution is technology agnostic, and can therefore be implemented using various different products and software. For example, the server 400 could include products such as ServiceNow or Amazon Lex, the voice call module 408 could include products such as Genesys Cloud or Amazon Connect, the web client 304 could include products such as .NET or Python, the remote management module 500 could include products such as Nexthink or N-able, and the NLU module 404 could include products such as Google DialogFlow.

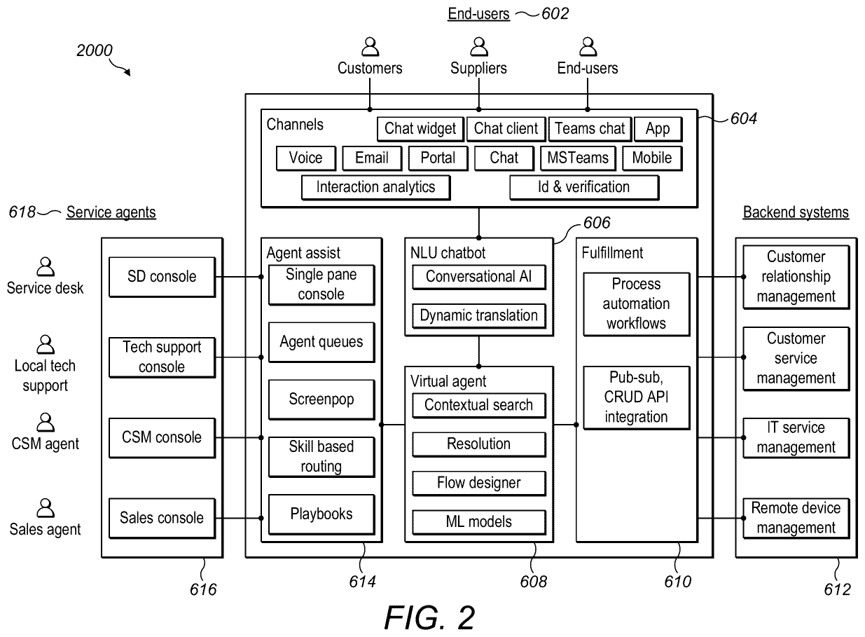

FIG. 2 shows a logical architecture 2000 of a secure communication system, in this case an omnichannel virtual agent system, in an exemplary embodiment of the present invention. As can be seen in FIG. 2, the omnichannel solution supports a wide range of end users 602, including staff directly working for customers of the omnichannel operator, e.g. airlines and airports, as well contractors and subcontractors working on behalf of those customers, e.g. baggage handlers. The solution also supports suppliers, corporate users and field agents of the omnichannel operator itself. These users 602 are equivalent to user 100 of FIG. 1.

Box 604 shows the various interaction channels supported by the omnichannel system. As seen in box 604, the end users 602 may interact via a variety of communication channels including voice, email, portal, chat and mobile. Each of these channels may be accessed via several devices and client applications, such as device 300 of FIG. 1. The system also enables centralised management of all interactions, regardless of which channels they came through. This facilitates better reporting and analytics of how users are contacting the omnichannel operator for support. Finally, users interacting with the system are identified and authenticated so that appropriate security and access controls can be applied when exposing any services and data to the users. Specifically, the end users 602 accessing the omnichannel system will typically make requests requiring operational access. Secure access therefore needs to be ensured to protect the end user's company's operational data in the backend systems, as well as ensuring privileged access to control the elements of the device, such as restarting a service or rebooting a device. The authentication process will be described in more detail in relation to FIGS. 3a and 3b below.

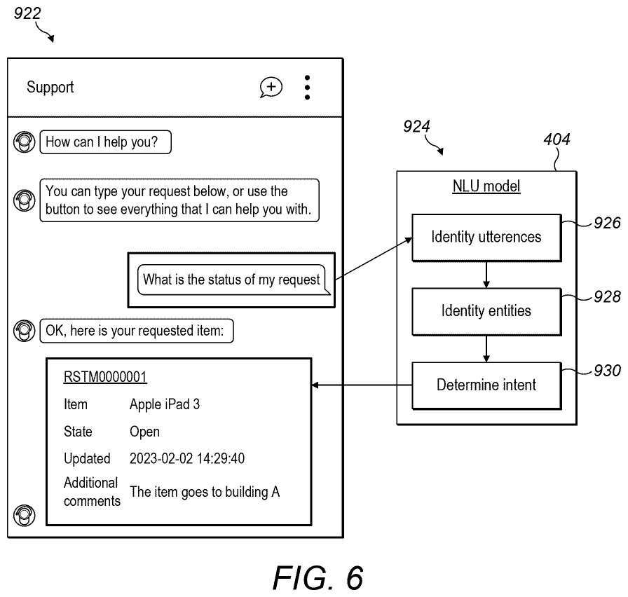

Interaction sessions are turned into conversations and handled by the natural language chatbot shown in box 606, equivalent to the NLU module 404 of FIG. 1. A cloud based chatbot service may be used for box 606 in some embodiments. Any voice interactions can be transcribed to text (e.g. via the voice call module 408 and the speech to text module 410 of FIG. 1) and then processed by the chatbot and the response converted back to speech to relay back to the user. The natural language understanding capability may be driven by machine learning models, which may include enhanced vocabulary and ATI specific training models. The chatbot may also be able to translate between various languages. These features will be discussed in more detail below in relation to FIGS. 6 to 8b. The translation may use a cloud-based translation service, such as Google Translate or Azure Cognitive Services Translator.

Box 608 shows the virtual agent function, equivalent to the virtual agent 402 of FIG. 1. The virtual agent 402 contains the intelligent, automated conversation flows to enable self-service fulfilment of customer requests, based on the intent identified by the natural language chatbot (i.e. NLU module 404,606). Common service requests and issues are resolved by the virtual agent without any human intervention. This may include context search through a service catalog or knowledge base. The automated flows may also make calls to other systems of record to retrieve data required to fulfil the request. The virtual agent can also transfer the user to a live, human agent 200 if the user requests so or if the virtual agent is unable to assist.

Box 610 shows the fulfilment backend of the omnichannel system. In box 610 there are further workflows and integrations with the backend systems 612 to complete the request and provide a response to the user.

While resolving a customer issue, controlled access is required to a range of backend systems 612. This may include ticketing systems that track incidents and requests, Customer Relationship Management (CRM) systems that contain information related to customers and their entitlements, and automation and remote management systems that manage the workstations and other devices used by the end users 602. Specifically, the backend systems may include:
Customer Relationship Management (CRM) systems to provide a response to a customer account query;
Customer Service Management (CSM) systems to provide response to a customer care query;
IT Service Management (ITSM) systems to provide a response to an IT issue that the customer has;
Remote Management systems to perform automated actions on a device remotely, to resolve an issue.

Lastly, box 614 shows the agent assistance facilities which enable the omnichannel operator's service agents 618 (equivalent to the live agent 200 of FIG. 1) to respond effectively when the interactions are directed to them from the virtual agent 402,608. The system ensures that the agents have access to the history of the conversation that the end user 100,602 has had with the virtual agent and any triage that has been performed. There may be various different agent consoles 616 (equivalent to agent console 406 of FIG. 1) each tailored to different types of agents, including: Service Desk Agents, Tech Support agents, CSM agents, Sales agents, and the like. The agents may be organised into queues, with requests being routed automatically to available agents based on their skills and availability.

In some embodiments, each of boxes 606, 608, 610 and 614 may be included in the server 400 of FIG. 1. The Remote Management back end system 612 may be included in the remote management module 500 of FIG. 1.

### User Authentication and Access Control

As mentioned, the omnichannel operator may store operational and service management data related to each of its customers, and is required to keep customer data secure and segregated for each customer. Therefore when an employee of a particular customer (i.e. a user 100) interacts with the omnichannel system (i.e. the secure communication system 1000), the system must ensure that the user only has access to data and services belonging to that customer.

To solve this problem, the system maintains data segregation by storing customer data in separate domains. Access to data is controlled by the company (organisation) that the end user 100 belongs to. However, the omnichannel operator does not manage the identities of the end users 100 as they are employees of customer organisations. It is not viable to authenticate each customer end user against a register stored by the omnichannel operator, as the end users (i.e. employees) of each customer are managed by the customer organisations and not the omnichannel operator. Therefore the omnichannel system cannot identify and authenticate users by their individual identities. Instead, the secure communication method 3000 of FIG. 3a is used.

FIG. 3a shows a flow chart of a secure communication method 3000 according to an embodiment of the present invention. The secure communication method 3000 may be performed between the device 300 and the server 400 of FIG. 1.

In step 702, generic user identification information based on a current user account 302 logged into on the device 300 is sent from the device 300 to the server 400. The generic user identification information is information that is sufficient to identify the particular organisation of the customer of the omnichannel operator, but is not dependent on the identity of the specific end user (i.e. employee) currently using the device 300.

In some embodiments, the generic user identification information may include an organisation name associated with the current end user account 302 logged into on the device. Additionally or alternatively, the generic user identification information may include a location associated with the device 300. For example, in an embodiment of the secure communication method 3000 applied to an ATI scenario the generic user identification information may include an airline name or ground handling agency name as the organisation name. Further, in some embodiments, the generic user identification information may also include a specific airport in which the device 300 is installed as the location.

In step 704, the server 400 identifies if the generic user identification information corresponds to an allowed entity pre-registered with the server. An allowed entity is an entity pre-registered with the server with permission to access the computer program 402. The server 400 may check the generic user identification information against a list of allowed entities to perform the identification. The identification by the server 400 that the generic user identification information corresponds to an allowed entity is not dependent on the identity of the specific end user 100 using the device 300.

Specifically, an allowed entity pre-registered with the server 400 may be any of: an organisation name with permission to access the computer program 402, a location of the device 300 with permission to access the computer program 402, or both a specific organisation name and device location pair with permission to access the computer program 402. For example, in an embodiment of the secure communication method 3000 applied to an ATI scenario the generic user identification information may include both an airline name or ground handling agency name in addition to the specific airport in which the device is installed. The server may then check the airline/ground handling agency name and airport location pair against a list of allowed airline/ground handling agency name and airport location pairs.

If the generic user identification information is identified as corresponding to an allowed entity, the method 3000 continues to step 706. In step 706, the server 400 sends to the remote management module 500 an identification token associated with the identified allowed entity. The identification token is a token unique to that allowed entity which is not stored on the device 300 and is only made accessible to the device 300 by the server 400 (via the remote management module 500).

In some embodiments, the identification token is a digest code generated by performing a hash function on either the organisation name of the allowed entity, the device location of the allowed entity, or the organisation name and location pair of the allowed entity. The hash function may use SHA256 encoding in some embodiments. Using a digest code as the identification token allows the identity of the user to be obfuscated when the identification token is transmitted in the following steps.

In some embodiments, the server 400 may include a stored list of identification tokens for each allowed entity pre-registered with the server. These identification tokens may be generated for each allowed entity during the pre-registration with the server 400. The server 400 can select from this list the identification token for the allowed entity that the generic user identification information is identified as corresponding to, and send this identification token to the remote management module 500. Alternatively, it is also possible for the identification token to be generated by the server 400 on the fly, in response to identifying the generic user identification information as corresponding to an allowed entity.

In step 708, upon receiving the identification token, the remote management module 500 runs a remote action on the device 300 that sent the generic user identification information to the server 400 in step 702. The remote management module 500 has stored thereon a register of all devices registered with the omnichannel operator and runs the remote action on the device 300 using the stored register entry for that device 300.

The remote action run by the remote management module 500 passes the identification token to the device 300. In this way, the identification token is only passed on to device 300 which initially sent the generic user identification information to the server 400 in step 702 if the device is registered with the remote management module 500 (i.e. is registered with the omnichannel system operator). This prevents unauthorized devices (i.e. any devices not preregistered with the omnichannel system operator) from being able to receive the identification token from the server 400.

In step 710, upon receiving the identification token from the remote management module 500, the device 300 sends the identification token back to the server 400.

In step 712, the server 400 compares the identification token received from the device 300 in step 710 with the identification token that the server sent to the remote management module 500 in step 706. If the server finds a match between the identification token sent in step 706 and the identification token received in step 710, the server 400 allows the device 300 to access the computer program 402. If the identification token sent in step 706 and the identification token received in step 710 do not match, then the server will not allow the device 300 to access the computer program 402.

The secure communication method 300 therefore allows the server 400 to control access to the computer program 402, such as the virtual agent function discussed above. This authentication is done without knowing the identity of the specific end user (i.e. person) operating the device 300, or the specific password of the current user account 302 logged into on the device, but instead uses only generic user identification information based on the current user account 302 logged into on the device 300. The current user account 302 may be a specific user account unique to the end user operating the device 300, or may be a shared account to which various end users from the organisation of the allowed entity have access to. In either case, only the abstracted generic user identification information affects whether the device 300 is allowed access to the computer program 402.

Further, using the generic user identification information and identification token to authenticate the access to the computer program also advantageously avoids the need for interactive authentication. For example, if authentication were to be performed at the level of the specific end user operating the device, the end user would need to be prompted for a username and password each time they wished to access the computer program. Authenticating via the generic user identification information and identification token instead can be performed without any specific end user input being needed.

In the above described method, the server 400 can check if the generic user identification information corresponds to an organisation that is allowed to access the computer program 402, or corresponds to a device location that is allowed to access the computer program 402, and only grant access to the computer program 402 if a match is detected. Further, in the case that the pre-registered allowed entity includes both an organisation name and a device location pair, the server 400 can only allow access when the generic user identification information corresponds to both of the organisation name and location pair. This can be particularly beneficial in an ATI scenario, where access for a particular organisation at one airport can be allowed, whilst access for that same organisation at another airport is prevented as the relevant organisation airport pair does not appear on the list of allowed entities.

Further, when the device 300 requests access to the computer program 402, the device is authenticated based on the identification token sent in step 710, rather than based on the generic user identification information initially sent by the device 300. The identification token is not stored locally on the device 300 but needs to be obtained from server 400, via the remote management function 500. Only devices registered with the remote management module 500 are able to receive the identification token from the server 400, as the identification token is sent via the remote management module 500 using the register of devices, and thus security is increased. In particular, if a malicious third party sought to access the computer program 402 (i.e. the omnichannel system) with a non-registered device, the authentication would necessarily fail, as the unregistered device would be unable to obtain the correct identification token from the server 400 via the remote management module 500.

In the case that the device 300 is allowed access to the computer program 402, based on a successful match between the identification tokens sent and received, the server can still prevent the device 300 from accessing other functionality or data from which the allowed entity lacks permission. For example, the computer program 402 may include a plurality of functionalities, for which each allowed entity is entitled to different levels of access. The particular allowed entity (i.e. organisation name and/or location) to which the user of the device 300 belongs is known via the authentication method 3000 FIG. 3a, and therefore the server may only allow access to functionality to which that allowed entity is entitled. Similarly, the server may only allow access to data for which the identified allowed entity has permission for. The server 400 therefore allows authenticated users to access certain applications and data using role-based authorisation.

In particular, in one embodiment data for a plurality of organisations may be stored in a data storage unit, with data for each organisation stored in a different domain. The server 400 may have stored thereon a list of all identification tokens and the corresponding storage domains for which that identification token has permission to access. The server 400 can therefore prevent the device 300 from accessing any storage domain other than the domain containing data of the organisation of that allowed entity corresponding to that identification token. Therefore only data for the organisation associated with the current user account logged into on the device may be accessed. In this way, security of each organisation's (i.e. customer's) data can be ensured.

FIG. 3b shows a flow chart of a secure communication method 4000 according to an embodiment of the present invention. The method 4000 of FIG. 3b is the same as the method 3000 of FIG. 3a, except that a number of further optional steps have been included. In FIG. 3b the method 4000 is applied to a scenario where the generic user identification information includes an airline name and airport pair.

The method begins in step 802, where the end user 100 using the device 300, in this case a workstation, clicks on shortcut to initiate connection to the computer program 402. In this embodiment the computer program 402 is a virtual agent chatbot, however other computer programs may be used. The clicking of the shortcut by the user of the workstation 300 triggers a script to make a REST call to the server 400.

In step 804, a REST call is made to a verify-user scripted API endpoint of the server 400. One example of the details for the REST call are shown below:

Endpoint: GET https: //${sita-
server}/api/siae/airport user/verify
Authorisation: Bearer access_token
Query Params: generic_user_identification_information,
hostname, device_id, remote_management_module_engine_name

The REST call sends to the server 400 the generic user identification information based on the current user account logged into on the workstation 300. In this case, the generic user identification information includes an airline name and an airport location of the workstation, for example AA: LHR. Therefore authentication for accessing the virtual agent function in this embodiment is performed based on a combination of the airline and airport codes associated with the current user account logged into on the workstation 300.

Further, the REST call may optionally include one or more of the following query parameters:
hostname: the computer name of the workstation, e.g. MIAGCKB090;
device_id: unique ID of the workstation as registered in the remote management module, e.g. 1ab7cf04a94ed7e6071aee0;
remote_management_module_engine_name: the remote management module manager (engine) node that manages the workstation.
   These query parameters provide the server 400 with the details on how to reach the workstation through the remote management module 500 (as done in steps 814 and 816 below).

The inbound REST API request in step 804 may be authenticated using OAuth. This improves security by passing a token instead of credentials with every request.

The workstation 300 then waits for response from the server 400 on a Named Pipe 806, and the method proceeds to step 808, where the scripted API service obtains the identification token, in this case a SHA256 digest code, associated with an allowed entity to which the generic user identification information corresponds. Again here the allowed entity is an airline name and airport location pair e.g. AA: LHR, pre-registered with the server 400 as allowed to access the virtual agent function 402.

A Javascript snippet is shown below, which gives one example of how the digest code identification token can be generated using a SHA256 security algorithm. The digest code may be generated on the fly. Alternatively, the digest code may be generated during preregistration of the allowed entity with the server, and retrieved from a look up table of all allowed entities and corresponding identification tokens (digest codes) in step 808.

// Get identity digest code
var ident_code = SncAuthentication.encode(generic username, “zyz”,
“HmacSHA256”);

The use of a hash function for generating the identification token means that instead of passing the generic user identification information (e.g. AA: LHR) in clear text, a hashed identification token is passed in the following HTTP calls. In other words, a hash function is applied to the airline and airport code pair (i.e. the allowed entity corresponding to the generic user identification information) to produce a digest code, before sending then across the network, resulting in increased security.

In the case that the generic user identification information does not correspond to any allowed entity, no digest code will be obtained, and the initial REST call will timeout with no access to the virtual agent function being allowed by the server 400.

Next at step 810, in the case that a digest code is successfully obtained, an one-time authentication token is generated by the server 400. This one-time authentication token is an optional additional layer of security for each session which may be used in conjunction with the identification token, and will be discussed in more detail below. The one-time authentication token may be stored in memory 812 for a predetermined period of time, for example 24 hours. In some embodiments, the one-time authentication token may be a random six-digit authentication code, for example created using the following Javascript code:

```
// Generate random auth_code
var digits = ‘0123456789’;
var auth_code = ‘’;
for (var j = 0; j > −1; j++) {
  auth_code = getAuthCode( );
  if (auth_code.indexOf(‘0’) != 0) {
    break;
  }
}
```

At step 814 both the identification token (i.e. digest code) and one-time authentication token are passed to remote action 816 running on the remote management module 500 via an outbound REST API call. One example of details for the REST call are shown below:

Endpoint: POST
https://${portal}/api/remoteaction/v2/run
Authorisation: OAuth 2.0
Query Params:
raUID, deviceUid, portal, engineUID, script

As shown above, the REST call may optionally include one or more of the following query parameters:
raUID: Remote Action ID
deviceUid: workstation device ID, i.e. the device_id of step 804
Portal: remote management module portal address
engineUID: remote management module engine (node) ID that manages the workstation i.e. the remote_management_module_engine_name of step 804
Script: name of the remote action script

The remote action 816 on the remote management module 500 targets the required workstation 300 and runs a local script on the workstation 300, and passes the identification token and one-time authentication token to the workstation 300 in step 818. Here the required workstation 300 is the particular workstation that initially sent the generic user identification information to the server 400 in step 804. To target the required workstation, the remote management module 500 uses the register of all devices registered with the omnichannel operator that is stored on the remote management module 500. Further, the remote management module 500 may identify the required workstation based on one or more of the query parameters sent to the server with the REST call in step 804 (which are passed on to the remote management module 500 via the query parameters listed above in the REST call of step 814).

Once the identification token and one-time authentication token have been passed to the workstation, the local script writes to the waiting named pipe 806. The workstation 300 may then proceed further, by launching the web client chatbot 304 on the workstation and passing the identification token and one-time authentication token to the virtual agent 402 running on the server 400 at step 820.

Next, in steps 822 and 824, the virtual agent program 402 on the server 400 runs a script action to match the received identification token with the identification code obtained in step 808 and sent by the server in step 814. Further, the script action matches the received one-time authentication token with the one time authentication token generated in step 810 (stored in the code log 812) and sent by the server in step 814.

If a correct match is found for both the identification token and one-time authentication token, the virtual agent chatbot session is established in 826. The user 100 is granted access via the workstation 300 and the chatbot starts conversation and progresses to topic discovery. If either of the identification token or one-time authentication token do not correctly match the tokens sent previously in step 814, the request to access the chatbot is rejected in step 828, meaning the user 100 is denied access and the conversation exits.

The method 4000 of FIG. 3b again allows authentication using only generic user identification information without knowing the identity of the specific end user (i.e. person) operating the device 300.

Further, the identification token (digest code) is sent to the workstation 300 so that it can be used by the client application on the workstation to log in with the server and access the virtual agent function. The server 400 only recognises users via their digest code, however the workstation 300 does not have the digest code stored thereon and instead needs to get it from the server first. Sending the tokens (both identification token and one-time authentication token) from the server 400 to the workstation 300 via the remote management module 500 allows the server 400 to confirm it is communication with the particular work station 300 claimed in the REST call of step 804.

Put another way, in the method 4000 the steps 814, 816 and 818 perform the function of providing an alternative channel to send the tokens (needed to log in with the server 400) to the user. The alternative channel is via the remote management module 500. Thus, the method prevents malicious parties using a device not registered with the remote management module 500 from spoofing the workstation device ID, as the remote management module 500 would only send the tokens necessary for login in with the server to the actual workstation that made the initial REST call.

Additionally, step 820 performs the function of sending the tokens back to the server 400 for to verify the user and allow the transaction/authentication to complete (i.e. logging in with the server). This method replaces the need for the user to enter a password each time they wish to access the virtual agent function, thus enabling the authentication to be performed without active involvement by the user.

As well as providing the same advantages of the method 3000 of FIG. 3a, the method 4000 of FIG. 3b provides a number of further advantages. In particular, in the method 4000 of FIG. 3b, both the identification token and the one-time authentication token must be matched to allow access to the computer program 402 (the virtual agent function). This introduces a further round of verification in which the workstation 300 then needs to send both of these tokens to the server 400 to launch the virtual agent. The server 400 will only allow the request for accessing the virtual agent function if, as well as receiving the correct identification token, the incoming one-time authentication token matches the one-time authentication token the server 400 had previously generated and is awaiting a connection on.

The one-time authentication token is generated every time a user 100 accesses the system, and therefore allows for additional security based on session. The workstation 300 will only be able to access the virtual agent and establish a session if the workstation possesses the particular the one-time authentication token for that session. In other words, after a predetermined period of time from generation of the one-time authentication token, the one-time authentication token will expire and the server will not allow access to the virtual agent function using that one-time authentication token. After the one-time authentication token has expired, the entire method 4000 will then need to be repeated, to reauthenticate the user. In this way, the sessions can be prevented from persisting for longer than desired, meaning that a malicious party having knowledge of the identification token alone would not be enough to access the omnichannel system. The predetermined period of time for expiry of the one-time authentication token may be the same as the length of time the one-time authentication token is stored in the memory 812 in some embodiments.

Lastly, in the case that a malicious third party somehow had access to a workstation 300 registered with the remote management module 500, the method would still prevent the third party from accessing the virtual agent. The workstation generates the generic user identification information from the current user account logged into on the workstation 300. Access to this user account with generic user identification information corresponding to an allowed entity is restricted to employees of the organisation of the allowed entity. Therefore the third party would be unable to access the virtual agent without having access to a user account to generate the generic user identification.

Further, in some embodiments, the method can also prevent spoofing of the generic user identification information in order to access the virtual agent function. To prevent the malicious third party sending spoofed generic user identification information from a registered workstation 300, a check may be performed that the identification token passed to the workstation 300 from the remote management module 500 in step 818 (or step 708 of method 3000 of FIG. 3a) matches the current user account logged into on the workstation. The request will only proceed if the generic user identification information in the initial request (used by the server 400 to obtain the identification token) corresponds to that of the logged in user. Therefore the malicious third party would need access to a user account corresponding to an allowed entity as well as to a workstation 300 registered with the remote management module 500 in order to access the virtual agent function.

### Virtual Agent Function

Previously, when the ground handling staff in the ATI have encountered issues with equipment, assistance has been requested by raising a ticket with a help desk, or telephoning a field engineer to request assistance. These options can result in slow response times and can be time consuming and increase workload for those required to provide the assistance. Inability to fix issues in time can result in delays with passenger and baggage handling. Self-service via a virtual agent function is therefore desirable for all parties.

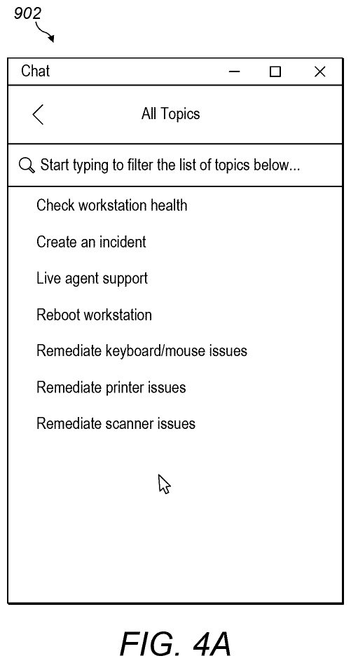

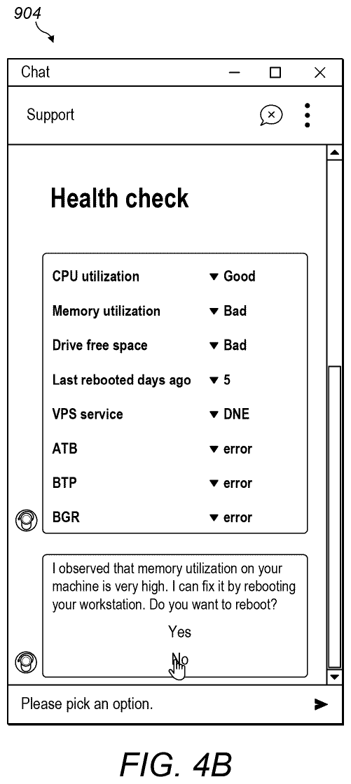

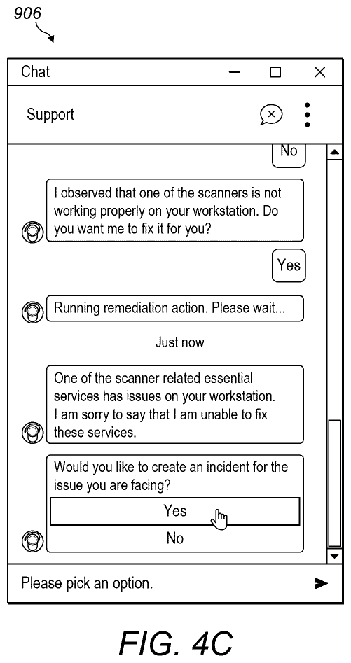

Various features of a virtual agent function which may be used as the computer program 402 in the above described embodiments will now be described in relation to FIGS. 4A to 8B. Again the following description is based on a ATI scenario, however it should be understood that the following embodiments are not limited thereto.

Returning to FIG. 1, in the case that the computer program 402 is a virtual agent function, the user 100 of the device 300 can input an input query to the virtual agent function 402. For example, in the case that the virtual agent function is an automated chatbot the input query is a text command input via the device 300, e.g. a via keyboard. In the case that the virtual agent function is an automated voicebot the input query is a voice command input via the device 300, e.g. a via headset.

In either case, the input query is processed using the NLU module 404 to determine an intent of the input query. In the case of a voicebots virtual agent function, the input voice command is converted, via the speech to text module 410, into a text command prior to the processing by the NLU module 404. The virtual agent function 402 then performs an automated action based on the determined intent.

In some embodiments, either in addition to or as an alternative to the user inputting an input query and the virtual agent using the NLU module 404 to determine the intent of the query, the virtual agent function may present a plurality of prompts to the user 100 on the device 300. For example if the virtual agent is a chatbot, the virtual agent may display a number of clickable options on the device. If the virtual agent is a voicebot, a number of prompts may be read out to the user 100 via the device 300, for example an interactive voice response (IVR) method may be used. In either case, the user 100 may input a selection of one of the prompts, and the virtual agent function 402 may perform a predetermined automated action based on the selected prompt.

### Self-Service Automation Using Virtual Agent

FIGS. 4a to 4c show an example self-service interaction with a virtual agent function 402 in an embodiment of the present invention. In the embodiment of FIGS. 4a to 4c, the virtual agent is a chatbot in which user inputs are obtained via clickable prompts. FIGS. 4a to 4c show screenshots of the chatbot conversation as would be visible on the workstation 300 to the user 100.

In step 902 in FIG. 4a, the virtual agent 402 presents a list of prompts relating to automated actions that the virtual agent can perform. The user 100 selects “Check Workstation Health” as the automated action. The virtual agent then performs a health check on the workstation 300 and proceeds to step 904 shown in FIG. 4b, where a summary report card is displayed with key performance metrics and status of key services. The virtual agent suggests further automated remediation actions such as rebooting the workstation 300, based on the results of the health check, to which the user 100 may select a response via yes or no prompts.

As shown in step 906 in FIG. 4c the user may select “yes” to the virtual agent fixing an issue with a peripheral device such as a scanner connected to the workstation 300. Such automated remediation actions are performed on the workstation 300 via the remote management module 500. If an automated remediation action is unsuccessful, the virtual agent may ask the user if they wish to log an incident via a prompt, or speak to a live agent 200.

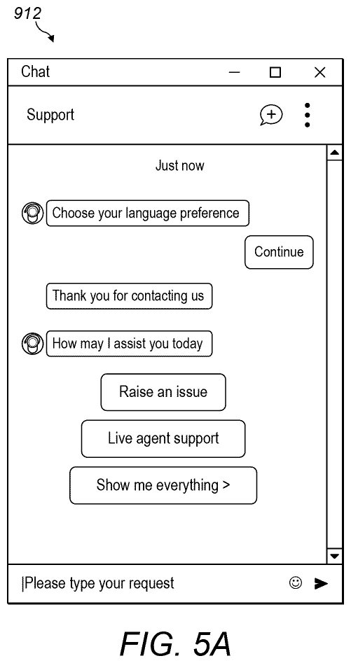

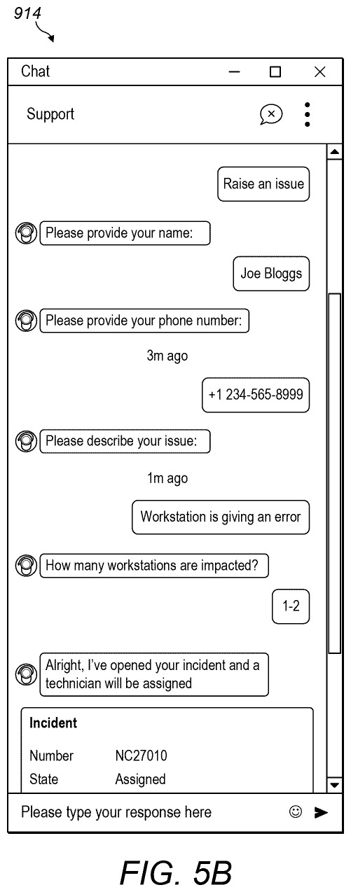

FIGS. 5a and 5b show another example self-service interaction with a virtual agent function 402 in an embodiment of the present invention. In the embodiment of FIGS. 5a and 5b, the virtual agent is a chatbot which user inputs are obtained via both textual inputs processed by the NLU module 404 and via clickable prompts. FIGS. 5a and 5b show screenshots of the chatbot conversation as would be visible on the workstation 300 to the user 100.

In step 912 in FIG. 5a, the user 100 selects “Raise an issue” as the automated action. In step 914 in FIG. 5b, the virtual agent then automatically logs an incident with a central database, seeking various pieces of information from the user and processing the user's responses using the NLU module 404.

In general, various other automated actions may be performed by the virtual agent function 402. These include but are not limited to:
instructing the remote management module 500 to perform a remote action on the device 300;
instructing the remote management module 500 to reboot the device or a peripheral device connected to the device 300;
instructing the remote management module 500 to restart a service running on the device 300;
instructing the remote management module 500 to perform a remediation action on the device or a peripheral device connected to the device 300;
instructing the remote management module 500 to perform a health check on the device, and optionally displaying a report of the health check on the device 300;
logging a record with a central database;
creating an incident report with a central database;
checking the status of an existing incident report or record.

These automated remote actions may be triggered by the virtual agent while the user is in conversation with the chatbot/voicebot, in some embodiments.

The virtual agent program 402 may be integrated with various backend systems, such as those shown in box 612 of FIG. 2. In some embodiments, the virtual agent 402 can fulfil requests and update integrated service management systems through REST API calls.

In some embodiments, an automated action can include retrieving data from a data storage unit, such as a central database, and outputting the data to the user 100 of the device 300. The user 100 may make queries for data relevant to a particular allowed entity. Such data may be private data for that allowed entity, such as account data or billing data or the like. Therefore the retrieving of the data for that allowed entity may only be allowed by the virtual agent if the authentication method of FIG. 3a or 3b has been successfully performed and the current user account 302 logged into on the device 300 has been confirmed as corresponding to that allowed entity. In this way, the retrieving of data by the virtual agent is conditional on the organisation name associated with the current user account 302 logged into on the device 300 and/or the location associated with the device 300.

In some embodiments an automated action can include initiating a communication channel with a live agent 200, as described above in relation to FIG. 1.

In some embodiments, an automated action can include the virtual agent 402 accessed on a first device 300 logging a fault with a second device with a central database. For example, if a second user has a problem with their device (the second device), they can alert the user 100 of the first device 300, who can then log a fault on the second user's behalf. This can be particularly beneficial when the second user has an issue meaning that they cannot not log into their workstation (the second device) or they cannot not launch the virtual agent web client on their workstation. In this case, they can request that their colleague on another workstation (the first device) logs an incident or contacts a live agent 200 on their behalf.

Using the omnichannel system to access self-service via the virtual agent function 402 advantageously allows end users such as airline agents or ground staff to rapidly resolve common issues themselves via the automated actions. Automation and quick resolution of issues is an important as ground staff at airports usually require time-critical resolution of issues to avoid delays in passenger and baggage handling. Further, such self-service reduces the workload on field engineers, enabling them to attend to more complex issues sooner.

### Natural Language Understanding (NLU)

As mentioned above, the virtual agent function of the omnichannel system uses an NLU module 404 to determine the user's intent from the input. The NLU module 404 may use machine learning based NLU services, which may be cloud based in some embodiments. An NLU based virtual agent allows users to interact with the virtual agent in a conversational mode, rather than navigating through clickable prompts or interactive voice response (IVR) options.

FIG. 6 shows another example self-service interaction with a virtual agent function 402 in an embodiment of the present invention. In the embodiment of FIG. 6, the virtual agent is a chatbot which user inputs are obtained via textual inputs processed by the NLU module 404. FIG. 6 shows a screenshot 922 of the chatbot conversation as would be visible on the workstation 300 to the user 100, along with a flow diagram 924 of the processing performed by the NLU model of the NLU module 404.

As shown in FIG. 6, the user 100 inputs a query to the virtual agent chatbot, in this case asking “What is the status of my request”. This input query is an example of a natural language utterance, in other words the different ways a user can express an intent (i.e. ask for something). For example, instead of asking “What is the status of my request”, the user may have instead asked “What is the status of my tickets” or “Is my issue fixed yet”. In step 926, the NLU model identifies the utterance input by the user.

Next, at step 928 the NLU model identifies the entities in the utterance. The entities are objects or contexts for an action, such as a particular device, case number, or an employee's name for example. In the above examples, the entity is “request”, “tickets” and “issue” respectively.

At step 930, the NLU model determines the user's intent based on the utterance and entity/entities. The user's intent is what a user wants to do, for example perform an action such as submitting a service ticket or getting an update on an order. In the example of FIG. 6, the intent is determined as a request for the virtual agent to check the status of an IT ticket of the user. In this way, the NLU model converts a user's natural language utterance into an intent.

The virtual agent can then perform the relevant automated action in response to this intent. The virtual agent runs the action which maps to the determined intent and identified utterance. For example, in FIG. 6 the virtual agent chatbot displays to the user their existing IT ticket RSTM0000001.

As mentioned, the NLU model may be a machine learning based model. In the ATI in particular, the omnichannel operator and their customers often use lots of ATI specific terminology which conventional machine learning NLU data sets do not cater for. Further, a user may input an acronym rather than the full phrase. Therefore in some embodiments of the present invention, the NLU model may be expanded to include a vocabulary containing ATI specific terms and phrases. In other words, the NLU machine learning model of the NLU module 404 may be trained using vocabulary containing ATI specific terms and phrases. Training based on this vocabulary helps the NLU model understand words and phrases that it may encounter from the users.

For example, an example utterance with ATI terminology could be:
WorldTracer Bag Management not receiving BSM messages
   The term “WorldTracer” and the acronym “BSM” are therefore added to the vocabulary and the NLU models retrained. The NLU model is then able to make correct predictions about the user's intent based on the utterance.

In some embodiments, the training data may be expanded to include the following vocabulary types:
Regular: a word or phrase that is not commonly used, such as ATI terminology
Pattern: a regular expression that can capture particular formats such as email addresses.

### Dynamic Translation

The end users 100 of the omnichannel system may be global in some embodiments, and various different users may input queries to the virtual agent function in various different languages. Further, the live agents 200 using the omnichannel system may also have their own preferred language. Lastly, the virtual agent program 402 and NLU module 404 will use a default language such as English.

In some embodiments, the virtual agent function can provide for real time dynamic language translation. In particular, the virtual agent chatbot or voicebot may translate in real time conversations between a user 100 using a first language and either the virtual agent 402 or a live agent 200 using a second language. The virtual agent may also translate tickets and transactional data provided by the user in their preferred language into a second language so that support agents working on those tickets (such as the service agents 618 of FIG. 2) are able understand the user's query/issue and act accordingly.

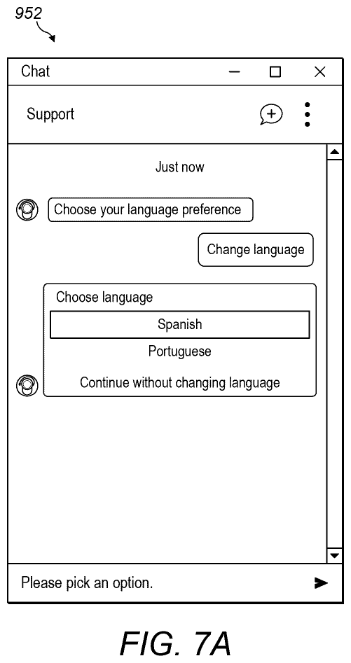

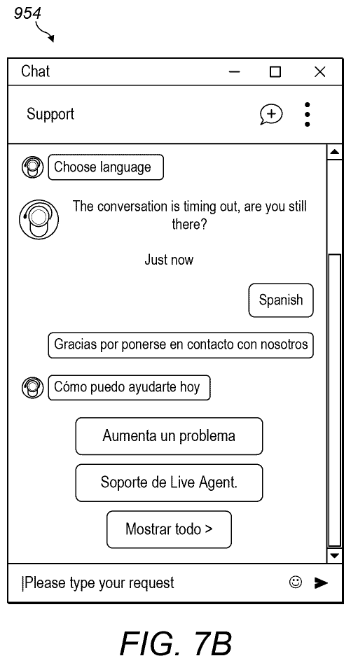

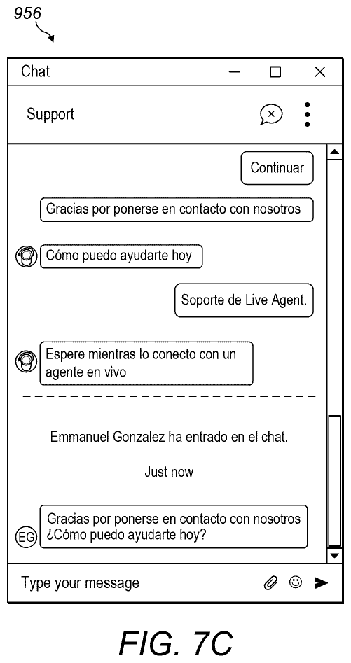

FIGS. 7a to 7c show an example self-service interaction with a virtual agent function 402 in an embodiment of the present invention. In the embodiment of FIGS. 7a to 7c, the virtual agent is a chatbot. FIGS. 7a to 7c show screenshots of the chatbot conversation as would be visible on the workstation 300 to the user 100.

In step 952 shown in FIG. 7a, the user 100 is prompted to select their preferred language. Spanish is selected by the user 100 in this case. The default language of the virtual agent function 402 is English in this case.

In step 954 shown in FIG. 7b, the virtual agent 402 then proceeds to converse with the user 100 using Spanish. In the case that the user's input is in a different language to the language which the NLU model has been trained to process (the default language), the input query may be translated from the input language into the language of the NLU model, prior to the processing by the NLU module 404. Further, any output by the virtual agent, e.g. a follow up question for the user or an automated action based on the determined intent, may be translated from the default language of the virtual agent and NLU model back to the user's preferred language. The translations may be performed by a dynamic translation module (not shown), which may be in the server 400 or in the cloud in some embodiments.

In step 956 shown in FIG. 7c, the user 100 requests (in Spanish) that the virtual agent connects the user to a live agent. The dynamic translation module translates this request into English, and then the NLU module 404 determines the intent of the user based on the English translation. The virtual agent then performs the automated action of connecting the user 100 into a live chat with a live agent 200 in FIG. 7c.

In the present embodiment, the live agent's preferred language is English, compared to the user's preferred language of Spanish. The omnichannel system 1000 may perform real time dynamic translation to translate chat conversations into both the user's and live agent's preferred languages. For example, the dynamic translation module may translate an input in Spanish by the user 100 into English prior to the input being displayed on the live agent's workstation. Similarly, the live agent's response in English may be translated back into Spanish, before being displayed to the user 100 at the workstation 300.

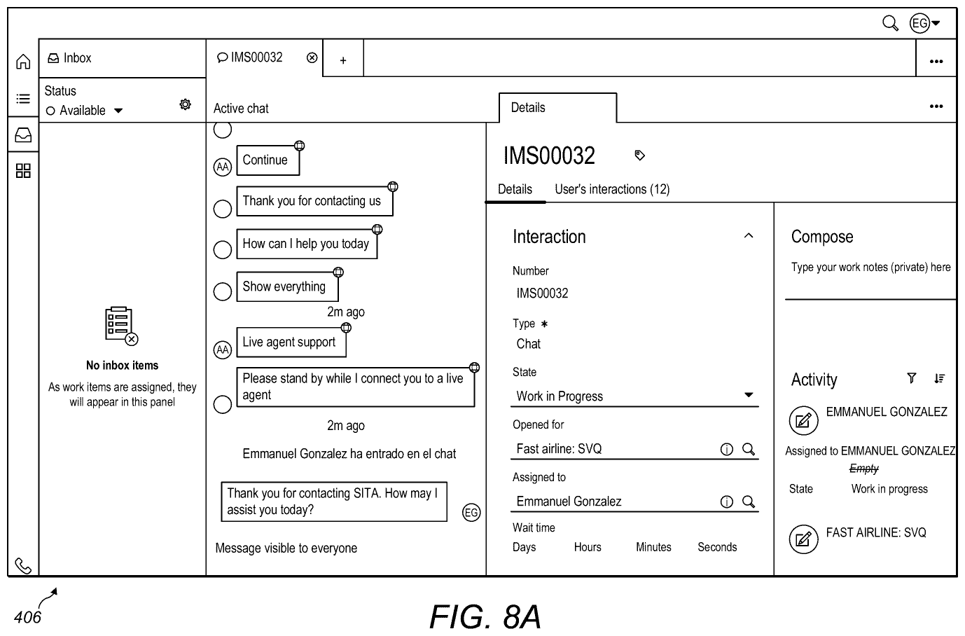

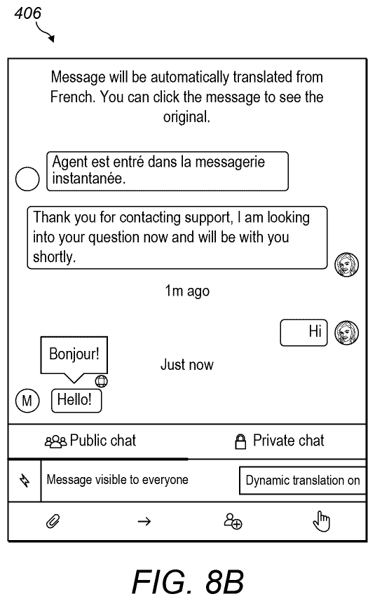

An example of this dynamic translation is shown in FIG. 8a, which shows an agent console 406 in one embodiment, where the conversation of FIG. 7c has been dynamically translated in real time into English for the agent 200.

Further, FIG. 8b shows an example of an agent console 406 in another embodiment, where a conversation with an end user 100 messaging in French is dynamically translated in real time into English for the live agent 200. In the embodiment of FIG. 8b, a notification at the top of the live agent's chat window shows the source language of the user 100. The live agent 200 can enable and disable dynamic translation in their chat window per chat session.

In each of the above embodiments, the omnichannel system 1000 can dynamically translate conversations between the user and live/virtual agent on the fly. The translation may be performed using a cloud translation service, for example Google Translate. As well as the user-agent conversation, interaction and incident data may also be translated. This enables live agents 200 and the virtual agent 402 to converse freely with users 100.

Lastly, in some embodiments the virtual agent may be capable of language detection, so that conversations with a user who has selected a preferred language can be routed to a live agent who that is equipped to deal with that language.

Although described separately, the features of the embodiments outlined above may be combined in different ways where appropriate. Various modifications to the embodiments described above are possible and will occur to those skilled in the art without departing from the scope of the invention which is defined by the following claims.

1. A method of secure communication between a device and a computer program running on a server, the method comprising the steps of:
sending, from the device to the server, generic user identification information based on a current user account logged into on the device;
identifying, by the server, the generic user identification information as corresponding to an allowed entity pre-registered with the server;
sending, from the server to a remote management module, an identification token associated with the allowed entity, said remote management module having stored thereon a register of registered devices;
running, by the remote management module, a remote action on the device using the stored register entry for that device, wherein the remote action passes the identification token to the device;
sending, from the device to the server, the identification token; and
allowing the device to access the computer program based at least in part on a match between the identification token sent by the server and the identification token received by the server from the device.

2. The method of claim 1, further comprising the steps of:
generating, by the server, a one-time authentication token;
sending, from the server to the remote management module, the one-time authentication token along with the identification token;
passing the one-time authentication token to the device along with the identification token;
sending, by the device to the server, the one-time authentication token along with the identification token;
allowing the device to access the computer program based at least in part on a match between the one-time authentication token generated by the server and the one-time authentication token received by the server from the device.

3. The method of claim 2, wherein the one-time authentication token is a randomly generated code.

4. The method of any preceding claim, wherein the generic user identification information comprises one or both of: an organisation name associated with the current user account logged into on the device, and/or a location associated with the device.

5. The method of claim 4, wherein the generic user identification does not include the identity of the specific person using the device.

6. The method of claim 4 or 5, wherein the identifying the generic user identification information as corresponding to an allowed entity comprises: confirming that the organisation name and/or the location appear in a list of allowed organisations and/or locations pre-registered with the server with permission to access the computer program.

7. The method of any of claims 4 to 6, wherein:
the generic user identification information comprises both the organisation name associated with the current user account logged into on the device and the location associated with the device; and
identifying the generic user identification information as corresponding to an allowed entity comprises: confirming that the organisation name and location pair appear in a list of allowed organisation and location pairs pre-registered with the server with permission to access the computer program.

8. The method of claim 6 or 7, wherein the identifying the generic user identification information as corresponding to an allowed entity is independent of the identity of the specific person using the device.

9. The method of any of claims 4 to 8, further comprising the step of:
preventing the device from accessing, via the computer program, data and/or functionality for which the organisation name and/or the location of the generic user identification information lacks permission.

10. The method of claim 4 or 9, wherein:
data for a plurality of organisations is stored in a data storage unit, with data for each organisation stored in a different domain; and
the method further comprises the step of: preventing the device from accessing, via the computer program, any storage domain other than the storage domain containing data of the organisation associated with the current user account logged into on the device.

11. The method of any preceding claim, wherein the server includes stored thereon an identification token for each allowed entity pre-registered with the server.

12. The method of any preceding claim, wherein each allowed entity is an allowed organisation name and/or location, preferably an allowed organisation name and location pair.

13. The method of claim 12, wherein the identification token is a digest code generated by performing a hash function on the allowed organisation name and/or location.

14. The method of any preceding claim, wherein the device is installed in one of: an airport, a train station, a port, or a transportation terminal.

15. The method of any of claims 1 to 13, wherein the generic user identification information comprises one or both of: an airline name or ground handling agency name associated with the user account logged into on the device, and/or an airport in which the device is installed.

16. The method of any preceding claim, wherein the device is any one of: a tablet; a smart phone; a mobile device; a common use terminal equipment, CUTE, device; a multi-tenancy device; a connected device; an airport workstation; a kiosk; a self-bag drop unit; a biosecurity device.

17. The method of any preceding claim, further comprising the step of:
sending, from the workstation to the server, along with the generic user identification information, at least one of: a hostname of the device; a device identification code for the device included in the register of registered devices; and information indicative of a node of the remote management module associated with the device.

18. The method of claim 17, further comprising the step of:
sending, from the server to the remote management module, along with the identification token, at least one of: the device identification code for the device included in the register of registered devices; and the information indicative of a node of the remote management module associated with the device.

19. The method of any preceding claim, further comprising the step of:
performing a check that the identification token passed to the device from the remote management module matches the current user account logged into on the device.

20. The method of any preceding claim, wherein the computer program is a virtual agent function.

21. The method of claim 20, further comprising the steps of:
inputting, by a user of the device, an input query to the virtual agent function;
processing the input query using a natural language understanding, NLU, module to determine an intent of the input query; and
performing an automated action by the virtual agent function based on the determined intent.

22. The method of claim 21, wherein the virtual agent function is an automated chatbot and the input query is a text command input via the device.

23. The method of claim 21, wherein:
the virtual agent function is an automated voicebot;
the input query is a voice command input via the device; and
the method further comprises: converting, via a speech to text module, the voice command to a text command prior to the processing by the NLU module.

24. The method of any of claims 21 to 23, further comprising the step of: translating the input query from a first language to a second language prior to the processing by the NLU module.

25. The method of any of claims 21 to 24, wherein the NLU module is trained using a data set comprising air transport industry specific terminology.

26. The method of any of claims 20 to 25, further comprising the steps of:
inputting, by a user of the device, a selection of a first prompt from a plurality of prompts presented by the virtual agent function on the device;
performing an automated action by the virtual agent function based on the selected prompt.

27. The method of any of claims 21 to 26, wherein the automated action is at least one of:
instructing the remote management module to perform a remote action on the device;
instructing the remote management module to reboot the device or a peripheral device connected to the device;
instructing the remote management module to restart a service running on the device;
instructing the remote management module to perform a remediation action on the device or a peripheral device connected to the device;
instructing the remote management module to perform a health check on the device, and optionally displaying a report of the health check on the device;
logging a record with a central database.

28. The method of any of claims 21 to 26, wherein the device is a first device, and the automated action comprises logging a fault with a second device with a central database.

29. The method of any of claims 21 to 26, wherein the automated action comprises retrieving data from a data storage unit and outputting the data to the user of the device.

30. The method of claim 29, wherein the retrieving data and/or outputting the data is conditional on an organisation name associated with the current user account logged into on the device and/or a location associated with the device.

31. The method of any of claims 21 to 26, wherein the automated action comprises initiating a communication channel with a live agent.

32. The method of claim 31, further comprising the steps of:
receiving an input from the user of the device in a first language;
translating in real time, by a dynamic translation module, the input into a second language set by the live agent.

33. A secure communication system, the system comprising:
a device;
a server having a computer program running thereon; and
a remote management module having stored thereon a register of registered devices;
wherein:
the device is configured to send to the server generic user identification information based on a current user account logged into on the device;
the server is configured to identify the generic user identification information as corresponding to an allowed entity and subsequently send an identification token associated with the allowed entity to the remote management module;
the remote management module is configured to run a remote action on the device using the stored register entry for that device, wherein the remote action is configured to pass the identification token to the device;
the device is configured to send the identification token to the server; and
the server is configured to allow the device to access the computer program based at least in part on a match between the identification token sent by the server and the identification token received from the device.
